(19) United States
(12) Patent Application Publication
(10) Pub. No.: US 2025/0319927 A1
(43) Pub. Date: Oct. 16, 2025

(54) VEHICLE CONTROL METHOD AND VEHICLE CONTROL DEVICE

(71) Applicant: Panasonic Automotive Systems Co., Ltd., Kanagawa (JP)

(72) Inventors: Toyoharu KURODA, Osaka Fu (JP); Hirofumi NISHIMURA, Kanagawa Ken (JP); Maiko OTANI, Kanagawa Ken (JP)

(73) Assignee: Panasonic Automotive Systems Co., Ltd., Kanagawa (JP)

(21) Appl. No.: 19/064,330

(22) Filed: Feb. 26, 2025

(30) Foreign Application Priority Data
Mar. 29, 2024 (JP) 2024-055769
Feb. 14, 2025 (JP) 2025-021981

(51) Int. Cl. B62D 15/02; B60K 35/10; B60K 35/22; B60R 1/25

(52) U.S. Cl. CPC B62D 15/0285; B60K 35/10; B60K 35/22; B60R 1/25; B60K 2360/1438

(57) ABSTRACT

In a vehicle control method of the present disclosure, before registering a teacher route, a display device is caused to display a vehicle image corresponding to a vehicle and display, around the vehicle image, an ambient area corresponding to periphery of the vehicle. When an operation device receives an operation of selecting the ambient area, data corresponding to the ambient area in a first three-dimensional object situation is deleted and the teacher route is registered. The vehicle image displayed on the display device includes a first side surface extending in a traveling direction of the vehicle image, a second side surface extending in the traveling direction and being located opposite the first side surface, one end in the traveling direction, and the other end opposite the one end in the traveling direction. The ambient area displayed on the display device is arranged along the first side surface.

### CROSS-REFERENCE TO RELATED APPLICATIONS

This application is based upon and claims the benefit of priority from Japanese Patent Application No. 2024-055769, filed on Mar. 29, 2024, and Japanese Patent Application No. 2025-021981, filed on Feb. 14, 2025; the entire contents of which are incorporated herein by reference.

### BACKGROUND OF THE INVENTION

### 1. Field of the Invention

The present disclosure relates to a vehicle control method and a vehicle control device.

### 2. Description of the Related Art

In general, parking spaces in houses are often narrow, which may cause difficulty in parking. Therefore, there is demand for vehicle control that enables automatic driving such as parking and exiting a parking space.

Under such circumstances, moving objects such as other vehicles and bicycles may be present around the periphery of the parking space in addition to a fixed object such as a wall. In recording-type automatic driving in which automatic driving (regenerative traveling) such as parking and exiting a parking space is implemented based on a traveling route during teacher traveling, when the presence or absence of peripheral three-dimensional objects is different between the teacher traveling and the regenerative traveling, there is a possibility that accuracy of the automatic driving deteriorates, for example, a deviation occurs in self-position estimation. For example, Patent Literature 1 discloses a technique for appropriately setting a stop position of a moving body present in a place that may be used for a purpose different from an original purpose.

However, for example, when a fixed object is handled as a moving object or when a moving object is handled as a fixed object, there is a possibility that accuracy of automatic driving deteriorates, and there is room for improvement in handling a peripheral moving object.

One of the problems to be solved by the present disclosure is related to recording-type automatic driving and is to suppress deterioration in accuracy during regenerative traveling caused by a peripheral moving object.

### SUMMARY OF THE INVENTION

A vehicle control method according to the present disclosure is executable by a vehicle control device provided in a vehicle, the vehicle including an operation device to receive an operation from a passenger, a sensor to acquire a situation of an external three-dimensional object, a display device being visually recognized by the passenger, and a traveling control device to control at least steering, the vehicle control method including: registering, by the operation of the passenger during teacher traveling, a teacher route based on a first three-dimensional object situation of the external three-dimensional object acquired by the sensor, the teacher traveling being performed by the vehicle to travel from a predetermined position to a parking target position: causing the traveling control device to control at least the steering to enable the vehicle to perform autonomous traveling from the predetermined position to the parking target position based on the teacher route and an external second three-dimensional object situation acquired by the sensor: and, before the registering the teacher route, causing the display device to display a vehicle image corresponding to the vehicle and display, around the vehicle image, an ambient area corresponding to a periphery of the vehicle, wherein the vehicle image displayed on the display device includes a first side surface part extending in a traveling direction of the vehicle image, a second side surface part extending in the traveling direction and being located opposite the first side surface part, one end part in the traveling direction, and the other end part opposite the one end part in the traveling direction, the ambient area displayed on the display device is arranged along the first side surface part, and, when an operation of selecting the ambient area is received by the operation device, data corresponding to the ambient area in the first three-dimensional object situation is deleted and the teacher route is registered.

### BRIEF DESCRIPTION OF THE DRAWINGS

FIG. 1 is a block diagram illustrating an example of an overall configuration of a vehicle according to an embodiment.

FIG. 2 is a schematic diagram illustrating an example of arrangement of cameras.

FIG. 3 is a schematic diagram illustrating an example of a configuration of an external appearance of the vehicle.

FIG. 4 is a diagram illustrating an example of a configuration in the vicinity of a driver's seat of the vehicle according to the present embodiment.

FIG. 5 is a block diagram illustrating an example of a hardware configuration of a vehicle control device according to the embodiment.

FIG. 6A is a diagram for describing an example of a teacher traveling mode according to the embodiment.

FIG. 6B is a diagram illustrating an example of a display screen displayed in map editing processing according to the embodiment.

FIG. 7 is a flowchart illustrating an example of a procedure of the map editing processing executed by the vehicle control device according to the embodiment.

FIG. 8 is a diagram illustrating an example of the display screen displayed in the map editing processing according to the embodiment.

FIG. 9 is a diagram illustrating another example of the display screen displayed in the map editing processing according to the embodiment.

FIG. 10 is a diagram illustrating still another example of the display screen displayed in the map editing processing according to the embodiment.

FIG. 11 is a diagram illustrating yet another example of the display screen displayed in the map editing processing according to the embodiment.

FIG. 12 is a diagram illustrating still yet another example of the display screen displayed in the map editing processing according to the embodiment.

FIG. 13 is a diagram illustrating a further example of the display screen displayed in the map editing processing according to the embodiment.

FIG. 14 is a diagram illustrating another further example of the display screen displayed in the map editing processing according to the embodiment.

FIG. 15 is a diagram illustrating still another further example of the display screen displayed in the map editing processing according to the embodiment.

FIG. 16 is a diagram illustrating still yet another further example of the display screen displayed in the map editing processing according to the embodiment.

### DETAILED DESCRIPTION OF THE PREFERRED EMBODIMENTS

Hereinafter, respective embodiments of a vehicle control device according to the present disclosure and a vehicle control method executable by the vehicle control device will be described with reference to the accompanying drawings.

It is noted that, in the following description of the present disclosure, components having the same or substantially the same functions as those described above with reference to the previous drawings will be denoted by the same reference numerals, and the description thereof may be appropriately omitted. In addition, in the case of representing the same or substantially the same part as well, the dimensions and ratios may be represented differently from each other depending on the drawings. Furthermore, for example, from the viewpoint of ensuring visibility of the drawings, in the description of each drawing, only main components are denoted by reference numerals, and even components having the same or substantially the same functions as those described above in the previous drawings may not be denoted by reference numerals.

It is noted that, in the description of the present disclosure, components having the same or substantially the same functions may be distinguished and described by adding alphanumeric characters to the end of reference numerals. Alternatively, when components having the same or substantially the same functions are not distinguished, the components may be collectively described by omitting alphanumeric characters added to the end of the reference numerals.

### First Embodiment

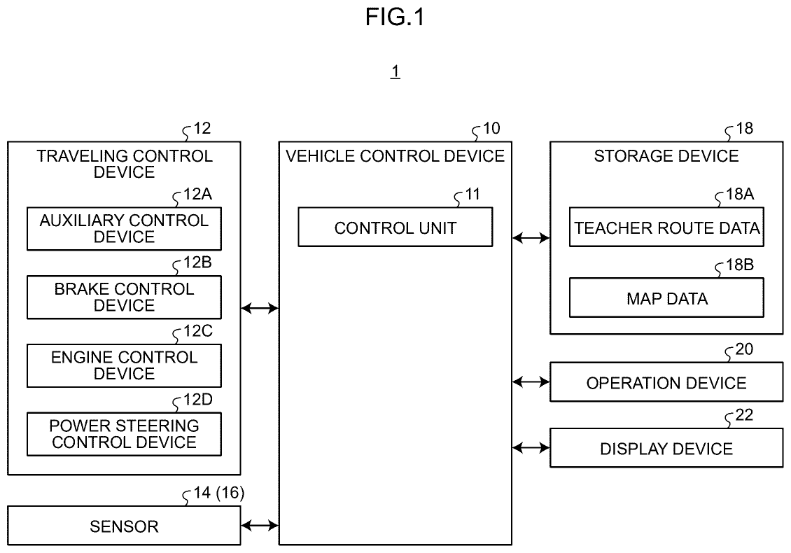

FIG. 1 is a block diagram illustrating an example of an overall configuration of a vehicle 1 according to an embodiment.

As illustrated in FIG. 1, a vehicle control device 10 according to the present disclosure is provided in a vehicle 1. The vehicle 1 includes at least a traveling control device 12, a sensor 14, a camera 16, an operation device 20, and a display device 22. In the example of FIG. 1, the vehicle 1 further includes a storage device 18.

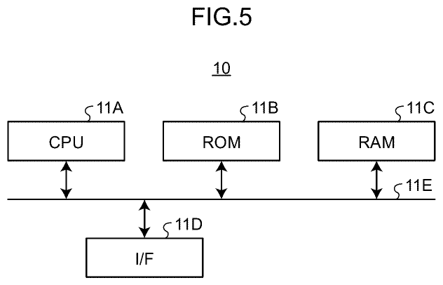

The vehicle control device 10 is connected to each of the traveling control device 12, the sensor 14, the camera 16, the storage device 18, the operation device 20, and the display device 22 via an I/F 11D (refer to FIG. 5) so as to be able to transmit and receive data or signals.

The traveling control device 12 is an example of a traveling control device that controls at least steering of the vehicle 1. Specifically, the traveling control device 12 is a unit that implements driving, braking, and turning motions necessary for traveling of the vehicle 1. For example, the traveling control device 12 includes a drive motor, a power transmission mechanism, a brake device, a steering device, and the like, and an electronic vehicle control device that controls those described above. The traveling control device 12 causes the vehicle 1 to travel by, for example, generating power with the drive motor and transmitting the power to wheels via the power transmission mechanism. The power transmission mechanism is, for example, a propeller shaft, a differential gear, a drive shaft, or the like.

Controlling at least steering means that the traveling control device 12 controls at least one of driving, braking, and turning motions necessary for traveling of the vehicle 1. Thus, controlling steering means that the traveling control device 12 controls at least one of a turning direction by steering, a vehicle speed and acceleration by accelerator steering, and deceleration and stop by brake steering.

Specifically, the traveling control device 12 includes an auxiliary control device 12A, a brake control device 12B, an engine control device 12C, and a power steering control device 12D. The brake control device 12B, the engine control device 12C, and the power steering control device 12D can be collectively referred to as an actuator control unit that controls the operation of the vehicle 1.

The auxiliary control device 12A is a control device that monitors the transmission state of the vehicle control device 10 and operates so as to execute appropriate degeneration control as a backup when the vehicle control device 10 fails. It is noted that even in a case where the vehicle control device 10 fails, if safety can be secured by providing a degeneration control function in the vehicle control device 10, the degeneration control is unnecessary.

The brake control device 12B is a control device that performs brake control of the vehicle 1. The brake control may be referred to as braking force control. For example, the brake control device 12B performs brake control of the vehicle 1 in accordance with enhancement and relaxation of the operation of a brake pedal by a passenger. Specifically, the enhancement of the operation of the brake pedal by the passenger means depression of the brake pedal by the passenger. Furthermore, the brake control device 12B performs brake control according to a peripheral video during autonomous traveling.

The engine control device 12C is a control device that controls an engine that generates driving force of the vehicle 1. The power steering control device 12D is a control device that controls power steering of the vehicle 1.

The sensor 14 is various sensors that are provided in the vehicle 1 and detect a traveling state of the vehicle 1 and a state around the periphery of the vehicle 1. The state around the periphery of the vehicle 1 includes a state of an external three-dimensional object.

The sensor 14 includes at least the camera 16. Furthermore, the sensor 14 includes at least one of light detection and ranging (LiDAR), radar, sonar, an ultrasonic sensor, and the like. The sensor 14 includes, for example, an accelerator opening sensor that detects an accelerator opening, a steering angle sensor that detects a steering angle of a steering device, an acceleration sensor that detects acceleration acting in the forward-and-rearward direction of the vehicle 1, a torque sensor that detects torque acting on a power transmission mechanism between wheels of the vehicle 1 and a drive motor, a vehicle speed sensor that detects a vehicle speed of the vehicle 1, a wheel speed sensor, a global positioning system (GPS), and the like. The sensor 14 outputs sensor information obtained by the detection to the vehicle control device 10.

Here, a three-dimensional object around the periphery of the vehicle 1, which can be acquired by the sensor 14, includes a fixed object that is an object around the periphery of the vehicle 1 and is not moved or can be regarded as not moving, and a moving object that is an object that can be moved. The fixed object may be, for example, a fixed installation object (body) such as a wall or a column. The moving object may be, for example, a portable installation such as a flower pot, a pedestrian, or an object such as another vehicle. In addition, the other vehicle may be various moving bodies such as a passenger car, a cargo vehicle, a vehicle, a motorcycle, a bicycle, and a kickboard, may be a moving body having a power source, or may be a human-powered moving body.

The camera 16 is a sensor that is mounted on the vehicle 1 to monitor the environment around the periphery of the vehicle 1. The camera 16 includes an imaging element that acquires an image of the environment around the periphery of the vehicle 1. The environment around the periphery of the vehicle 1 includes a situation of an external three-dimensional object. In the present embodiment, the camera 16 captures images of the periphery of the vehicle 1, and sequentially outputs the captured images to the vehicle control device 10. In the present embodiment, the camera 16 outputs, to the vehicle control device 10, a captured video including a plurality of captured images along the time series, which are obtained by capturing the periphery of the vehicle 1 along the time series. Hereinafter, the captured video may be simply referred to as a video. Furthermore, in the present embodiment, the camera 16 is also applied to an application of detecting a three-dimensional object (object) present around the periphery of the vehicle 1 and estimating the position of presence of the vehicle 1 from a positional relationship between the vehicle 1 and the object present around the periphery of the vehicle 1.

The position, the number of installations, and the capturing direction of the camera 16 are adjusted in advance so that the periphery of the vehicle I can be captured. For example, the vehicle 1 is provided with four cameras 16 arranged so as to be able to capture four directions of the forward direction, the rearward direction, the left direction, and the right direction of the vehicle 1. It is noted that the number of cameras 16 provided in the vehicle 1 is not limited to four.

The storage device 18 stores various pieces of data. In the present embodiment, the storage device 18 stores data such as teacher route data 18A and map data 18B. Details of the teacher route data 18A and the map data 18B will be described later.

The storage device 18 is, for example, an auxiliary storage device such as a hard disk drive (HDD), a solid state drive (SSD), or a flash memory. It is noted that at least part of the data included in the storage device 18 may be stored in an external storage device such as a server device provided outside the vehicle 1 and communicably connected to the vehicle control device 10.

The operation device 20 receives an operation from a passenger (user) of the vehicle 1 and acquires an operation result. The operation device 20 includes an operation mechanism related to a driving operation such as a steering wheel, a shift lever for shifting a transmission, an accelerator pedal, a brake pedal, a blinker lever, and a push-in switch, and an input device such as a keyboard, a touch panel, and a switch. The steering angle of the steering device is adjusted by the operation of a steering operation unit by a passenger. At least one of the keyboard, the touch panel, and the switch functions as an automatic parking instruction unit that receives an automatic parking start instruction. The steering wheel is an example of a steering operation unit. The steering wheel may be referred to as a handle.

The shift lever is an example of a forward-and-rearward movement operation unit. The forward-and-rearward movement operation unit switches at least forward movement and rearward movement of the vehicle 1. The brake pedal is an example of a brake operation unit. The brake operation unit is an operation unit for a brake that suppresses the speed of the vehicle 1. Thus, the brake operation unit receives an instruction to decelerate the vehicle 1. The operation device 20 may configure part of a human machine interface (HMI) or an in-vehicle infotainment (IVI).

The display device 22 is a display that outputs various images. The display device 22 is installed at a position visually recognizable by a passenger of the vehicle 1. Examples of the display include a liquid crystal display (LCD), an organic electro-luminescence (EL) display, and a projector. The display may be a touch panel display in which the display device 22 and the operation device 20 are configured to be integrated with each other. The display device 22 is an example of at least one of the HMI and the IVI.

It is noted that the display device 22 is not limited to one including only one display area. For example, the display device 22 may include a plurality of display areas.

In addition, the vehicle 1 may include a plurality of display devices 22. For example, the display device 22 may include a first display unit and a second display unit, and the first display unit and the second display unit serve as displays that output various images. The first display unit and the second display unit are display devices 22 configured as separate bodies. The first display unit and the second display unit may be arranged at different positions in the vehicle 1. For example, the first display unit may function as the IVI, and the second display unit may function as part of the instrument panel of the vehicle 1.

It is noted that the operation device 20 and the display device 22 may be configured to be integrated with each other as, for example, a touch panel display in which the operation device 20 serving as a touch panel is arranged to overlap with a display area of the display device 22. It is noted that each of the operation device 20 and the display device 22 is an example of the HMI.

It is noted that the operation device 20 may include, for example, a microphone and may be configured to be able to receive an operation by a voice input of a passenger (user) of the vehicle 1. In addition, the vehicle 1 may be provided with a speaker that outputs a notification sound, a warning sound, or a voice instead of or in addition to the display device 22. In this case, the notification in the information processing according to the present disclosure may be implemented by output of voice or the like. Furthermore, an operation such as selection or designation of the user for the notification may be implemented by voice input.

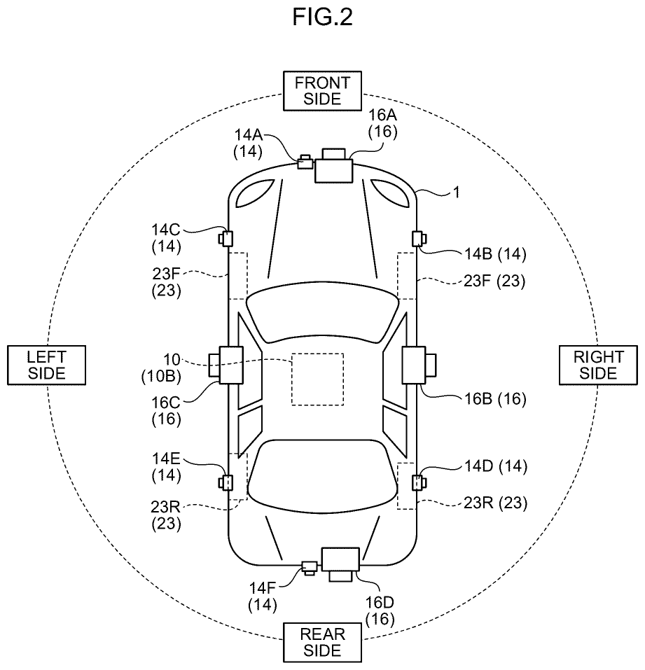

FIG. 2 is an explanatory diagram of an example of arrangement of the sensor 14 and the camera 16.

The vehicle 1 is provided with, for example, four cameras 16 (cameras 16A to 16D) so as to be able to acquire a situation outside the vehicle 1 in at least four directions of the front side, rear side, right side, and left side of the vehicle 1.

Specifically, for example, the camera 16 includes the camera 16A, the camera 16B, the camera 16C, and the camera 16D. The camera 16A is arranged on the front side of the vehicle 1 and captures an image of the front side of the vehicle 1. The camera 16A is an example of a first camera. The camera 16A may be referred to as a front camera. The camera 16B is arranged on the right side of the vehicle 1 and captures an image of the right side of the vehicle 1. The camera 16B is an example of a second camera. The camera 16C is arranged on the left side of the vehicle 1 and captures an image of the left side of the vehicle 1. The camera 16C is an example of a third camera. The camera 16D is arranged on the rear side of the vehicle 1 and captures an image of the rear side of the vehicle 1. The camera 16D is an example of a fourth camera. The camera 16D may be referred to as a rear camera, a rear-side camera, or the like.

It is noted that the number of cameras 16 provided in the vehicle 1 is not limited to four. In addition, regarding sensors that detect objects, such as LiDAR, radar, sonar, and an ultrasonic sensor included in the sensor 14, it is preferable that the arrangement positions, the number of arrangements, and the like are adjusted in advance so that the external situations of the right side, the left side, the front side, and the rear side of the vehicle 1 can be acquired. For example, as illustrated in FIG. 2, the sensor 14 includes sensors 14A to 14F. These sensors 14A to 14F are arranged in the vehicle 1 so as to be able to acquire external situations of the right side, the left side, the front side, and the rear side of the vehicle 1. It is noted that the sensor 14 that detects an object, such as LiDAR, radar, sonar, and an ultrasonic sensor, may be arranged only on the rear side of the vehicle 1.

Next, a configuration of the vehicle 1 will be described.

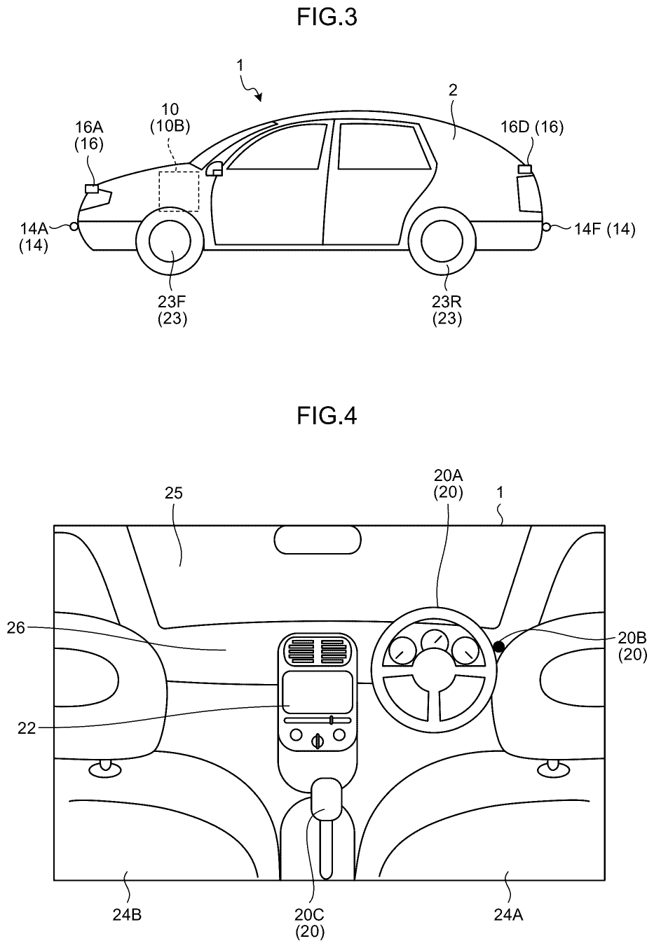

FIG. 3 is a schematic diagram illustrating an example of an external configuration of the vehicle 1.

The vehicle 1 includes a vehicle body 2 and two pairs of wheels 23 arranged in a predetermined direction on the vehicle body 2. The two pairs of wheels 23 include a pair of front tires 23F and a pair of rear tires 23R (also refer to FIG. 2). It is noted that FIGS. 2 and 3 illustrate an example in which the vehicle 1 includes four wheels 23. However, the number of wheels 23 provided on the vehicle 1 is not limited thereto.

Next, a configuration in the vicinity of the driver's seat of the vehicle 1 of the present embodiment will be described.

FIG. 4 is a diagram illustrating an example of a configuration in the vicinity of a driver's seat 24A of the vehicle 1 of the present embodiment.

The vehicle 1 includes the driver's seat 24A and a passenger seat 24B. A windshield 25, a dashboard 26, a steering wheel 20A, an operation button 20B, and a display device 22 are provided in front of the driver's seat 24A. Further, a shift lever 20C, which is a lever for shifting the transmission, is provided near the driver's seat 24A.

The steering wheel 20A, the operation button 20B, and the shift lever 20C are examples of the operation device 20.

The steering wheel 20A is provided in front of the driver's seat 24A and can be operated by a passenger. The rotation angle of the steering wheel 20A, namely, the steering angle is electrically or mechanically interlocked with a change in the direction of the front tire 23F serving as a steering wheel. It is noted that the steering wheel may be the rear tire 23R, or both the front tire 23F and the rear tire 23R may serve as a steering wheel.

The operation button 20B is a button capable of receiving an operation from the passenger. The operation button 20B may include a direction indicator. The position of the operation button 20B is not limited to the example illustrated in FIG. 4, and may be provided, for example, on the steering wheel 20A. Although one operation button 20B is illustrated in FIG. 4, a plurality of operation buttons 20B may be provided. In a case where the display device 22 also serves as a touch panel, the display device 22 may be an example of the operation device 20.

Referring back to FIG. 1, the description will be continued.

The vehicle control device 10 is an electronic control unit that integrally controls each unit of the vehicle 1.

The vehicle control device 10 controls the traveling control device 12 so that the traveling state of the vehicle 1 is optimized using sensor information, a video, and the like received from the sensor 14 and the camera 16, respectively. In addition, the vehicle control device 10 controls the traveling control device 12 to cause the vehicle 1 to perform autonomous traveling.

Here, a hardware configuration of the vehicle control device 10 of the present embodiment will be described.

FIG. 5 is a block diagram illustrating an example of a hardware configuration of the vehicle control device 10 according to the embodiment.

The vehicle control device 10 includes at least one processor (for example, a CPU 11A) and at least one memory (for example, a RAM 11C), and has a hardware configuration using a normal computer. For example, as illustrated in FIG. 5, the vehicle control device 10 includes the central processing unit (CPU) 11A, a read only memory (ROM) 11B, the random access memory (RAM) 11C, and an interface (I/F) 11D. The CPU 11A, the ROM 11B, the RAM 11C, and the I/F 11D are communicably connected to each other via a bus 11E. It is noted that each component of the vehicle control device 10 may be implemented by a combination of two or more components.

The CPU 11A is an arithmetic device that controls the overall processing of the vehicle control device 10. The RAM 11C stores data necessary for various types of processing by the CPU 11A. The ROM 11B stores programs and the like for implementing various types of processing by the CPU 11A. The I/F 11D is an interface that is connected to an external device or an external terminal via a communication line or the like and transmits and receives data to and from the connected external device or external terminal.

The vehicle control device 10 may be implemented by an electronic control unit (ECU) provided inside the vehicle 1, a domain control unit (DCU) such as a cockpit domain controller (CDC) in which plural ECUs are integrated, or a computer such as an on board unit (OBU). In this case, the vehicle control device 10 may transmit and receive information to and from another ECU installed in the vehicle 1 or a device connected to the vehicle 1 via an in-vehicle network including a controller area network (CAN), Ethernet (registered trademark), a universal serial bus (USB (registered trademark)), or the like in the vehicle 1, or may communicate with an information processing device outside the vehicle 1 via a network such as the Internet. Furthermore, the vehicle control device 10 according to the embodiment may be implemented by a single ECU or the like, or may be implemented by another ECU, a DCU, or an OBU that implements control of each function of the vehicle 1, such as power steering control, accelerator control, brake control, other charge control, or automatic driving control, or may be implemented by cooperation thereof.

The vehicle control device 10 is not limited to the CPU 11A, and may include various processors such as a graphics processing unit (GPU), an application specific integrated circuit (ASIC), and a field programmable gate array (FPGA).

Furthermore, the vehicle control device 10 may include various recording media and recording devices such as a hard disk drive (HDD), a solid state drive (SSD), and a flash memory as the auxiliary storage device.

It is noted that a program executed by the vehicle control device 10 according to the present embodiment may be provided by being recorded in a computer-readable recording medium (computer program product) such as a CD-ROM, an FD, a CD-R, or a DVD as a file in an installable format or an executable format.

In addition, the program executed by the vehicle control device 10 according to the present embodiment may be configured to be stored on a computer connected to a network such as the Internet and to be provided by being downloaded via the network. In addition, the program executed by the vehicle control device 10 according to the present embodiment may be provided or distributed via a network such as the Internet.

In addition, the program executed by the vehicle control device 10 according to the present embodiment may be configured to be provided by being incorporated in a ROM or the like in advance.

Next, a functional configuration of the vehicle control device 10 of the present embodiment will be described.

For example, at least one processor (for example, the CPU 11A) of the vehicle control device 10 loads a program stored in the auxiliary storage device (for example, the ROM 11B) into the main storage device (for example, the RAM 11C) and executes the loaded program, thereby implementing each function of the vehicle control device 10. It is noted that at least one processor of the vehicle control device 10 may be configured as a dedicated hardware circuit.

For example, in the vehicle control device 10, the CPU 11A implements at least one function including a function as a control unit 11. The control unit 11 integrally controls each unit of the vehicle 1.

It is noted that the control unit 11 controls, for example, steering, acceleration, deceleration, forward movement, and rearward movement of the vehicle 1 by the traveling control device 12, but may control only steering by the traveling control device 12 so that the passenger operates acceleration, deceleration, and forward movement.

The control unit 11 according to the present embodiment is configured to be able to switch a traveling mode between a teacher traveling mode and an autonomous traveling mode based on an input operation or the like to the operation device 20 by the user. It is noted that the traveling mode executable by the vehicle 1 may include various traveling modes other than the teacher traveling mode and the autonomous traveling mode.

The teacher traveling mode is a mode for registering a teacher route when the vehicle 1 performs autonomous traveling. The teacher route is a route obtained by teacher traveling from a predetermined position to a parking target position. In the teacher traveling mode, the vehicle 1 is controlled to travel by the driving operation of the user. Thus, in the teacher traveling mode, the control unit 11 controls the traveling control device 12 to travel in accordance with the driving operation by the user.

The autonomous traveling mode is a mode causing the vehicle 1 to perform autonomous traveling. In the present embodiment, the autonomous traveling mode means a mode in which the vehicle 1 performs regenerative traveling along the teacher route. In the autonomous traveling mode, the control unit 11 controls at least steering to control the traveling control device 12 so as to travel along the teacher route. In the autonomous traveling mode, the vehicle 1 is automatically controlled to travel by the vehicle control device 10 without depending on the driving operation of the user.

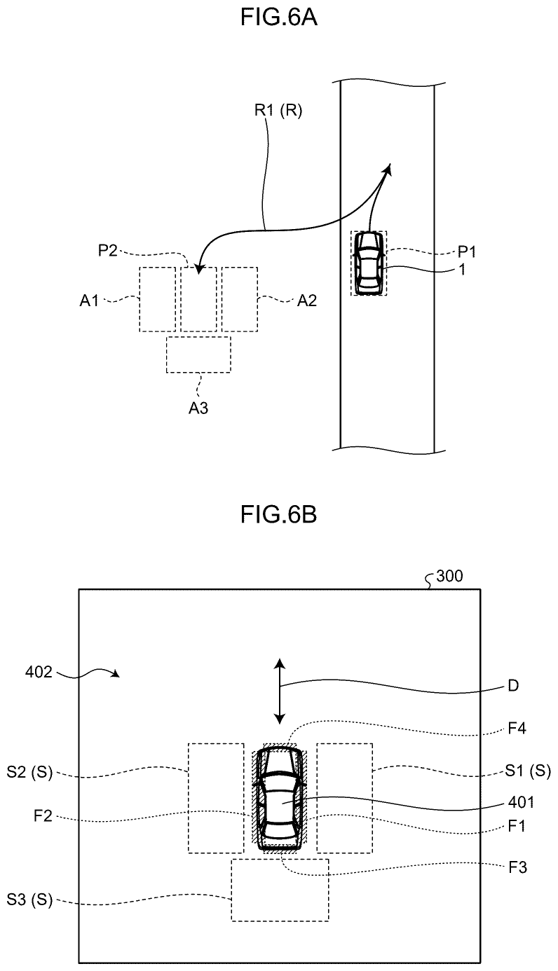

FIG. 6A is a diagram for describing an example of the teacher traveling mode according to the embodiment.

In the teacher traveling mode, the teacher traveling from a predetermined position P1 to a parking target position P2 is performed by the driving operation by the user. The parking target position P2 is, for example, a parking lot or the like, but the present disclosure is not limited thereto. Further, the predetermined position P1 may be any position of the user in the real space.

A traveling route R traveled by the teacher traveling is treated as a teacher route R1, and the teacher route data 18A of the teacher route R1 is stored in the storage device 18. At the time of teacher traveling, the user may perform driving operation so as to travel from the parking target position P2 toward the predetermined position P1, or may perform driving operation so as to travel from the predetermined position P1 toward the parking target position P2. When the vehicle 1 travels from the parking target position P2 toward the predetermined position P1 in the teacher traveling mode, the control unit 11 may generate the teacher route data 18A of the teacher route R1 in which the traveling direction of the traveling route R during teacher traveling is set to a reverse direction. When the vehicle 1 travels from the predetermined position P1 toward the parking target position P2 during the teacher traveling, the control unit 11 may generate the teacher route data 18A of the teacher route R1 in the traveling direction of the traveling route R during the teacher traveling. Details of generation of the teacher route data 18A will be described later.

In the autonomous traveling mode, the control unit 11 causes the vehicle 1 to autonomously travel to the parking target position P2 by controlling at least steering along the traveling route R obtained by the teacher traveling. It is noted that, in the autonomous traveling mode, the control unit 11 executes steering control of the vehicle 1 and forward-and-rearward acceleration/deceleration control, but at least part of the forward-and-rearward acceleration/deceleration control may be executed by the operation of a driver.

Next, control performed by the control unit 11 in each of the teacher traveling mode and the autonomous traveling mode will be described in detail.

### [In Teacher Traveling Mode]

First, the control of the control unit 11 in the teacher traveling mode will be described in detail.

The control unit 11 switches the traveling mode to the teacher traveling mode when receiving a signal indicating an instruction to start the teacher traveling mode by the operation of the operation device 20 by the user. Then, the control unit 11 executes the following processing in the teacher traveling mode.

The control unit 11 acquires sensor information indicating a traveling state of the vehicle 1 from the sensor 14. Then, the control unit 11 estimates the current position of the vehicle 1 based on a temporal change in a sensor value indicated by the sensor information. For example, the control unit 11 calculates a movement amount of the vehicle 1 from a reference position such as a traveling start position when the teacher traveling mode is started based on a temporal change in the vehicle speed and the yaw rate represented by sensor values, and estimates the current position of the vehicle 1 based on the movement amount.

It is noted that estimation accuracy of the current position based on the movement amount may be low. Therefore, the control unit 11 may use, as the current position, a result of correcting the estimated current position based on a video around the periphery of the vehicle 1, which is acquired by the camera 16.

The control unit 11 sequentially stores, in the storage device 18, the current positions of the vehicle 1, which are sequentially estimated along the traveling of the vehicle 1. Specifically, the control unit 11 sets, as the teacher route R1, the traveling route R at the time of teacher traveling represented by a group of current positions sequentially estimated from a time point when an instruction to start the teacher traveling mode is received until an instruction to end the teacher traveling mode is received, and stores the teacher route data 18A representing the teacher route R1 in the storage device 18.

The teacher route data 18A includes a group of pieces of traveling information for the respective positions which are current positions sequentially estimated at the time of teacher traveling. The traveling information includes, for example, an INDEX, a traveling position, an azimuth, a traveling direction, and reference traveling information. The INDEX is identification information of the traveling information. The traveling position is the estimated position of the vehicle 1. The azimuth indicates a direction of the vehicle 1 at the position. The traveling direction indicates a traveling direction of the vehicle 1 at the position, and is represented by, for example, forward movement or rearward movement. The reference traveling information is information indicating a traveling state or the like at the position. The reference traveling information is, for example, information such as a steering angle and a vehicle speed detected at each position during teacher traveling.

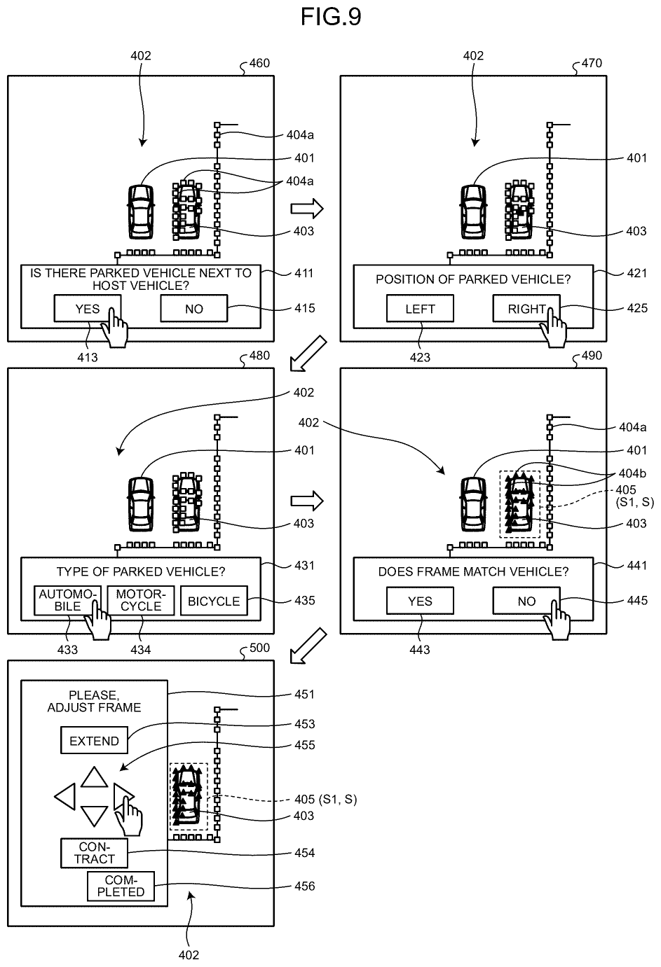

In addition, the map data 18B is map data in which feature points (for example, a feature point 404a in FIG. 9) around the periphery of the vehicle 1 at the time of traveling along the teacher route R1 are registered. At the time of the teacher traveling of the vehicle 1, the control unit 11 generates the map data 18B for estimating the current position of the vehicle 1 from the video captured by the camera 16. As a method of estimating the current position of the vehicle 1 from the video, a simultaneous localization and mapping (SLAM) method or the like is used.

The feature point is a feature point obtained by performing image analysis on a captured image captured by the camera 16 during teacher traveling. For example, the feature point is a point at which a characteristic image pattern can be obtained by analyzing a captured image in an object (for example, a tree, a wall, a column, or the like) or the like that can be a mark in the real view. The point is, for example, an edge part of the object. The map data 18B includes a plurality of feature points, and each of the feature points is identifiably registered for each feature point by being assigned an identification number.

The feature point is represented by feature point data including a three-dimensional position and a feature amount. The three-dimensional position of the feature point is a three-dimensional position of the feature point in the real space, and is represented by, for example, a three-dimensional orthogonal coordinate system (X, Y, Z). The feature amount of the feature point is a feature amount of the feature point represented by image analysis of the captured image. The feature amount of the feature point is, for example, luminance and density on the captured image, a scale invariant feature transform (SIFT) feature amount, a speeded up robust features (SURF) feature amount, or the like.

In the map data 18B, one feature point is registered for each identical three-dimensional position. It is noted that, for the identical three-dimensional position, a plurality of feature points may be registered in the map data 18B for each capturing position and capturing direction by the camera 16 at the three-dimensional position. In addition, the feature point data of the feature points registered in the map data 18B may further include image data of an object having the feature points.

During the teacher traveling, the control unit 11 determines coordinates of feature points in the real view based on, for example, stereo photogrammetry. Specifically, the control unit 11 reads a plurality of captured images captured at different timings, and correlates the identical feature points with each other, which commonly appear in the plurality of captured images. Then, for example, the control unit 11 estimates the temporary position of the vehicle 1 when the plural captured images are captured, and determines temporary coordinates of the feature point in the real view by the principle of triangulation. Then, for example, the control unit 11 performs bundle adjustment using the temporary position of the vehicle 1 and the temporary coordinates of the feature point in the real view as reference information, and calculates the formal position of the vehicle 1 and the formal coordinates of the feature point in the real view so as to minimize a reprojection error when each feature point in the real view is projected on all the captured images. Then, the control unit 11 stores, in the storage device 18, the map data 18B registering the feature point that is represented by the feature point data including the formal coordinates of the feature point in the real view as the three-dimensional position.

The three-dimensional position of the feature point registered in the map data 18B may be a position measured in advance using light detection and ranging (LiDAR) or a stereo camera without using the SLAM method. However, from the viewpoint of suppressing deterioration in position estimation accuracy, the SLAM method may be used.

It is noted that the control unit 11 may generate one piece of map data 18B including the entire teacher route R1, but may generate, as the map data 18B, pieces of partial map data at least partly non-overlapping with each other along the teacher route R1.

As described above, the control unit 11 executes the above-described processing in the teacher traveling mode. For this reason, in the teacher traveling mode, the control unit 11 generates the teacher route data 18A of the teacher route R1 obtained by the teacher traveling from the predetermined position P1 to the parking target position P2, and the map data 18B registering the three-dimensional position of each of the feature points around the periphery of the vehicle 1 during traveling along the teacher route R1 and the feature amount of each feature point, and stores the generated data in the storage device 18. In other words, during the teacher traveling in which the vehicle 1 travels from the predetermined position P1 to the parking target position P2 by the operation of the passenger, the control unit 11 registers the teacher route based on a situation (a first three-dimensional object situation) of an external three-dimensional object including data of the feature point of the three-dimensional object, which is acquired by the sensor 14 and/or the camera 16.

Then, the control unit 11 executes map editing processing before registering the teacher route data 18A and the map data 18B as teacher data related to one teacher route R1, for example, at the time of completion of teacher traveling in the teacher traveling mode, namely, before registering the teacher route. More preferably, the control unit 11 executes the map editing processing after the vehicle 1 in the teacher traveling arrives at the parking target position P2 and before the teacher route is registered.

In the teacher traveling mode, when the vehicle 1 is moved to the parking target position P2 through the driving operation by the user, a moving object, which is a three-dimensional object having a higher possibility of movement than a given degree, may be disposed in an ambient area A1 on the left side of the parking target position P2, an ambient area A2 on the right side thereof, and an ambient area A3 on the rear side thereof. There is a possibility that such a moving object is not present in the autonomous traveling mode.

Therefore, in the map editing processing, the control unit 11 according to the present disclosure causes the display device 22 to display a vehicle image corresponding to a host vehicle and an ambient area corresponding to the periphery of the vehicle image. This ambient area is displayed around the periphery of the vehicle image.

FIG. 6B is a diagram illustrating an example of a display screen 300 displayed in the map editing processing according to the embodiment.

The display screen 300 includes a vehicle image 401 indicating the host vehicle and an ambient area S (S1 to S3). Specifically, the vehicle image 401 and the ambient area S are displayed by being superimposed onto an external image 402.

The vehicle image 401 may be an icon of a composite image or an image of the vehicle 1 captured in the past. The external image 402 is, for example, an image based on at least one image obtained by imaging the periphery of the vehicle 1 by the camera 16. Furthermore, the external image 402 may be an image subjected to image processing including viewpoint transformation, or may be a bird's-eye view image (top view image) obtained by compositing images captured by a plurality of cameras 16. A known method may be used for generating the bird's-eye view image.

The vehicle image 401 includes a first side surface part F1, a second side surface part F2, one end part F3, and the other end part F4.

The first side surface part F1 is a side surface part in the traveling direction (direction of arrow D) of the vehicle image 401 in the vehicle image 401. The traveling direction of the vehicle image 401 is the traveling direction of the vehicle 1 represented by the vehicle image 401. Thus, the first side surface part F1 is an area corresponding to a side surface part in the traveling direction of the vehicle 1 representing the vehicle image 401 in the vehicle image 401.

The second side surface part F2 is a side surface part in the traveling direction (direction of arrow D) of the vehicle image 401 in the vehicle image 401 and is located opposite to the first side surface part F1. Thus, the second side surface part F2 is an area corresponding to a side surface part opposite to the first side surface part F1 in the side surface part in the traveling direction of the vehicle 1 represented by the vehicle image 401 in the vehicle image 401.

The one end part F3 is one end part in the traveling direction (direction of arrow D) in the vehicle image 401. Specifically, the one end part F3 is an area corresponding to a side surface on one end part side in the traveling direction (direction of arrow D) of the vehicle I represented by the vehicle image 401 in the vehicle image 401.

The other end part F4 is the other end part in the traveling direction (direction of arrow D) in the vehicle image 401. Specifically, the other end part F4 is an area corresponding to a side surface on the other end part side with respect to the one end part F3 in the traveling direction (direction of arrow D) of the vehicle 1 represented by the vehicle image 401 in the vehicle image 401.

The ambient area S displayed on the display device 22 is an area arranged along the first side surface part F1 of the displayed vehicle image 401.

Specifically, the ambient area S displayed on the display device 22 includes the first ambient area S1 and the second ambient area S2. The ambient area S may further include the third ambient area S3 in addition to the first ambient area S1 and the second ambient area S2. FIG. 6B illustrates, as an example, a mode in which the ambient area S includes the first ambient area S1, the second ambient area S2, and the third ambient area S3.

The first ambient area S1 is an ambient area S arranged along the first side surface part F1 of the vehicle image 401 displayed on the display device 22. The first ambient area S1 is an area corresponding to the ambient area A2 (refer to FIG. 6A) on the right side of the vehicle 1 in the real space. The first ambient area S1 displayed on the display device 22 has a rectangular shape. In the first ambient area S1, one side of the long side of the rectangle is arranged along the first side surface part F1 of the vehicle image 401.

The second ambient area S2 is an ambient area S arranged along the second side surface part F2 of the vehicle image 401 displayed on the display device 22. The second ambient area S2 is an area corresponding to the ambient area A1 (refer to FIG. 6A) on the left side of the vehicle 1 in the real space. The second ambient area S2 displayed on the display device 22 has a rectangular shape. In the second ambient area S2, one side of the long side of the rectangle is arranged along the second side surface part F2 of the vehicle image 401.

The third ambient area S3 is an ambient area S arranged along the one end part F3 of the vehicle image 401 displayed on the display device 22. The third ambient area S3 is an area corresponding to the ambient area A3 (refer to FIG. 6A) on the rear side of the vehicle 1 in the real space. The third ambient area S3 displayed on the display device 22 has a rectangular shape. In the third ambient area S3, one side of the long side of the rectangle is arranged along the one end part F3 of the vehicle image 401.

Further, when the operation device 20 receives a user operation of selecting the ambient area S in the map editing processing, the control unit 11 deletes data corresponding to the ambient area S in the situation regarding the external object (first three-dimensional object situation) acquired during the teacher traveling, and then registers a teacher route. The data corresponding to the ambient area S includes data of feature points of the external three-dimensional object corresponding to the ambient area S.

The control unit 11 may receive any one of a user operation of selecting only the first ambient area S1, a user operation of selecting only the second ambient area S2, and a user operation of selecting only the third ambient area S3. The control unit 11 may receive a user operation of selecting any two or more of the first ambient area S1, the second ambient area S2, and the third ambient area S3. For example, the control unit 11 may receive any one of a user operation of selecting the first ambient area S1 and the second ambient area S2, a user operation of selecting the first ambient area S1 and the third ambient area S3, a user operation of selecting the second ambient area S2 and the third ambient area S3, and a user operation of selecting the first ambient area S1, the second ambient area S2, and the third ambient area S3.

The control unit 11 then deletes data corresponding to the ambient area S having received the selected user operation in the situation regarding the external object (first three-dimensional object situation) acquired during the teacher traveling for the ambient area S having received the selected user operation among the first ambient area S1, the second ambient area S2, and the third ambient area S3, and then registers the teacher route.

As a result, it is possible to suppress a situation (second three-dimensional object situation) related to the external object acquired in the autonomous traveling mode from being different from a situation (first three-dimensional object situation) related to the external object registered in the map data 18B, and to suppress deterioration in accuracy of the host vehicle position estimation. For example, in a case where there is an object such as another vehicle near the side of the host vehicle, the reflection range of the other vehicle in the angle of view of the camera 16 provided so as to be able to capture the side becomes large, and the influence on the acquisition of a situation of a peripheral object during the teacher traveling and the regenerative traveling becomes large. Under such circumstances, by performing the map editing processing of deleting the data corresponding to the ambient area S and registering the teacher route, it is possible to suppress an increase in the influence in a case where there is another vehicle during the teacher traveling but there is no other vehicle during the regenerative traveling, and to prevent a situation in which the feature point cannot be sufficiently acquired in the vicinity of the parking target position P2 where particularly careful control is required.

### [In Autonomous Traveling Mode]

Next, the control of the control unit 11 in the autonomous traveling mode will be described in detail.

The control unit 11 switches the traveling mode to the autonomous traveling mode when receiving a signal indicating an instruction to start the autonomous traveling mode through the operation of the operation device 20 by the user. Then, the control unit 11 executes the following processing in the autonomous traveling mode.

The control unit 11 reads the teacher route data 18A and the map data 18B from the storage device 18, and controls the traveling control device 12 to perform autonomous traveling along the teacher route R1 represented by the teacher route data 18A.

The control unit 11 estimates the current position of the vehicle 1 based on the map data 18B and the captured image around the periphery of the vehicle 1 acquired by the at least one camera 16.

For example, the control unit 11 first collates the feature points extracted from the captured image of the camera 16 with the feature points stored in the map data 18B using pattern matching, feature amount search, or the like. Then, the control unit 11 randomly selects several (for example, 3 to 6) feature points among the feature points extracted from the captured image of the camera 16 and the feature points that can be collated with the feature points stored in the map data 18B.

Then, the control unit 11 estimates the current position of the vehicle 1 in the real space based on the positions of these several feature points in the captured image and the three-dimensional positions of the feature points registered in the map data 18B corresponding to the several feature points in the real space. At this time, the control unit 11 estimates the current position of the vehicle 1 by solving a PnP problem using, for example, a known method such as Lambda Twist (refer to, for example, the literature: Mikael Persson et al. “Lambda Twist: An Accurate Fast Robust Perspective Three Point (P3P) Solver.”, ECCV 2018, pp 334-349, published in 2018, http://openaccess.thecvf.com/content_ECCV_2018/papers/Mikael_Persson_Lambda_T wist_An_ECCV_2018_paper.pdf).

It is noted that, when collating the feature points extracted from the captured image of the camera 16 with the feature points stored in the map data 18B, the control unit 11 may calculate, for example, the current position of the vehicle 1 as a temporary position based on the movement amount of the vehicle 1 described above, and may narrow down the feature points to be collated with the feature points extracted from the captured image of the camera 16 among the feature points stored in the map data 18B with the temporary position as a reference.

Through the above-described processing, the control unit 11 estimates current position information including information related to the two-dimensional position (X coordinate, Y coordinate) of the vehicle 1 and the direction of the vehicle 1 in the real space as current position information indicating the current position of the vehicle 1 based on the map data 18B and the captured image of the periphery of the vehicle 1, which is acquired by the at least one camera 16.

Then, the control unit 11 causes the vehicle 1 to perform autonomous traveling from the predetermined position P1 toward the parking target position P2 along the teacher route R1 by controlling the traveling control device 12 so that the estimated current position of the vehicle 1 is a position on the teacher route R1 represented by the teacher route data 18A. Then, the control unit 11 stops the vehicle 1 at the parking target position P2.

When the vehicle 1 performs autonomous traveling along the traveling route R, the control unit 11 feedback-controls the traveling control device 12 so that the vehicle 1 moves along the teacher route R1 based on the estimated current position of the vehicle 1 and each position on the teacher route R1 represented by the teacher route data 18A.

In this manner, in the autonomous traveling mode, the control unit 11 causes the traveling control device 12 to control at least steering so as to enable the vehicle 1 to perform autonomous traveling from the predetermined position P1 to the parking target position P2 based on the teacher route and the situation of the external three-dimensional object (second three-dimensional object situation) including the data of the feature points of the three-dimensional object, which is acquired by the sensor 14 and/or the camera 16.

Hereinafter, an operation example of the vehicle 1 according to the embodiment will be described with reference to the drawings. It is noted that the processing to be described below is an example, and it is also possible to change the processing order, delete some processing, and add other processing. Furthermore, in the following description, description of contents already described will be appropriately omitted.

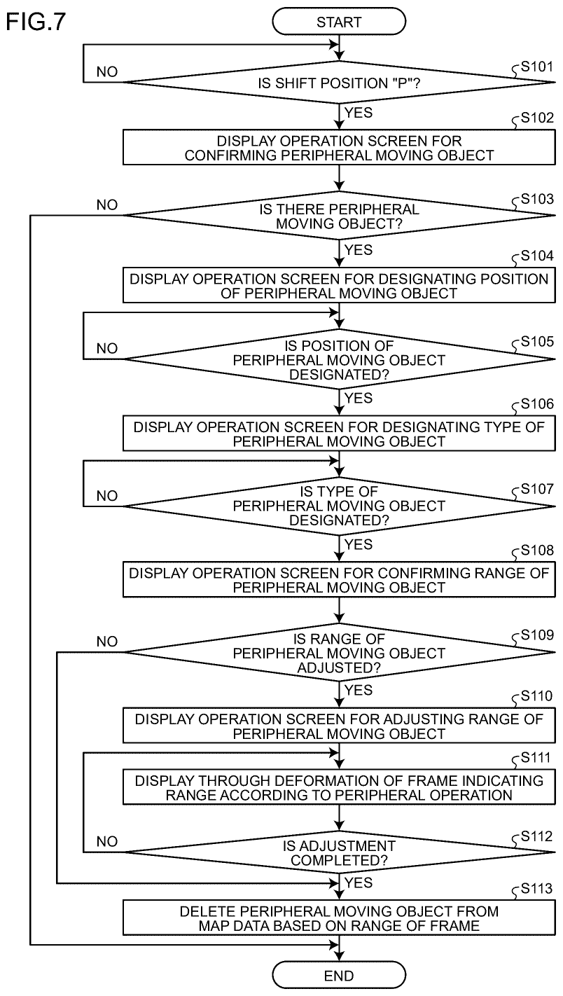

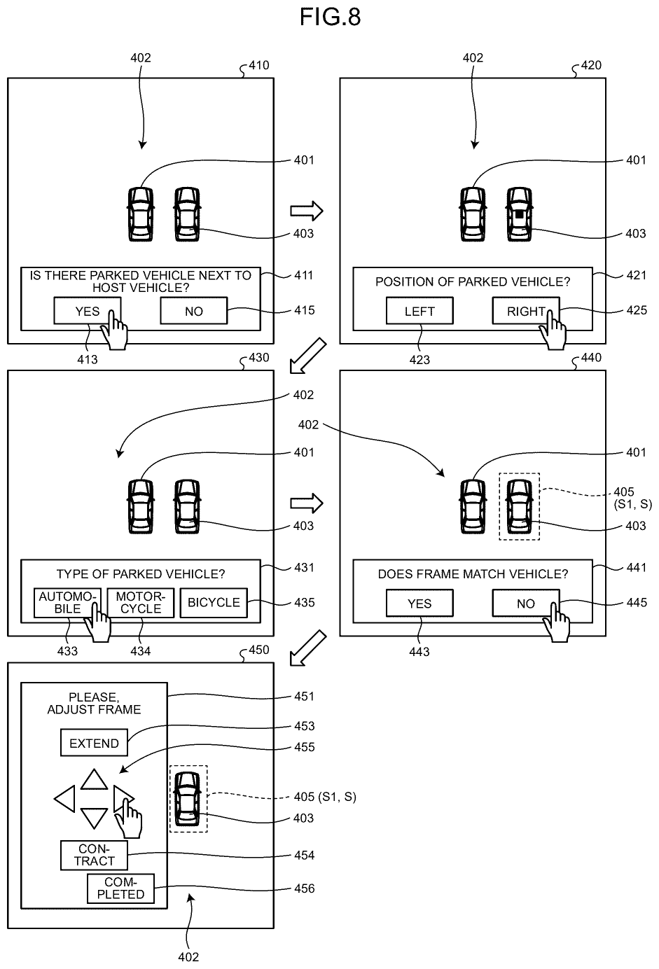

FIG. 7 is a flowchart illustrating an example of a procedure of the map editing processing executed by the vehicle control device 10 according to the embodiment. FIG. 8 is a diagram illustrating an example of a display screen displayed in the map editing processing according to the embodiment. FIG. 8 illustrates operation screens 410 to 450 each serving as a display screen in the map editing processing. Each of the operation screens 410 to 450 exemplified in FIG. 8 or each notification displayed on each of these operation screens is an example of an indication for requesting to select the ambient area S in which a three-dimensional object having a higher possibility of movement than a given degree is placed.

The procedure illustrated in FIG. 7 is executed in the teacher traveling mode.

The vehicle control device 10 determines whether a shift position is “P” (S101). When the shift position is not “P” (S101: No), the vehicle control device 10 repeats the processing of S101 until determining that the shift position is “P”.

Here, the determination as to whether the shift position is “P” is an example of the determination as to whether the teacher traveling is completed. It is noted that the determination as to whether the teacher traveling has been completed is not limited to the shift position, and may be implemented by determining whether a user has performed an operation indicating that the teacher traveling has been completed, such as displaying a completion button on a display screen during the teacher traveling by the display device 22 and pressing a completion button. Alternatively, the determination as to whether the teacher traveling has been completed may be implemented by determining whether a predetermined time has elapsed from the stop of the vehicle 1. The predetermined time may be predetermined and stored in, for example, an internal memory of the vehicle control device 10.

When the shift position is “P” (S101: Yes), the vehicle control device 10 displays the operation screen 410 for checking a peripheral moving object (S102).

As illustrated in FIG. 8, the operation screen 410 includes a vehicle image 401 indicating a host vehicle and an external image 402 indicating the ambient areas A1 to A3 of the host vehicle. Specifically, on the operation screen 410, the vehicle image 401 is displayed by being superimposed onto the external image 402.

The vehicle image 401 may be an icon of a composite image or an image of the vehicle 1 captured in the past. The external image 402 is, for example, an image based on at least one image obtained by imaging the periphery of the vehicle 1 by the camera 16. The external image 402 may be an image subjected to image processing including viewpoint transformation, or may be a bird's-eye view image (top view image) obtained by compositing at least one image.

When an object such as a moving object is present in the ambient areas A1 to A3, the operation screen 410 may further include a moving object image 403 indicating a peripheral moving object.

As illustrated in FIG. 8, the operation screen 410 includes a notification 411 such as “Is there a parked vehicle next to the host vehicle?”. The notification 411 includes operation buttons 413 and 415 of “Yes” and “No”, which respectively receive user operations.

The vehicle control device 10 determines whether there is a peripheral moving object (S103). For example, when the operation button 413 of “Yes” is selected on the operation screen 410, the vehicle control device 10 determines that there is a peripheral moving object. For example, when the operation button 415 of “No” is selected on the operation screen 410, the vehicle control device 10 determines that there is no peripheral moving object.

When there is no peripheral moving object (S103: No), the procedure illustrated in FIG. 7 ends.

When there is a peripheral moving object (S103: Yes), the vehicle control device 10 displays an operation screen 420 for designating the position of the peripheral moving object (S104).

As illustrated in FIG. 8, the operation screen 420 includes a notification 421 such as “Position of parked vehicle?” in addition to the vehicle image 401 and the external image 402. The notification 421 includes operation buttons 423 and 425 of “Left” and “Right”, which respectively receive user operations. It is noted that the number of operation buttons may be three as long as the operation buttons designate any one of the left, right, and rear areas corresponding to the ambient areas A1 to A3.

The vehicle control device 10 determines whether the position of the peripheral moving object is designated (S105). For example, when any one of the operation buttons 423 and 425 is selected on the operation screen 420, the vehicle control device 10 determines that the position of the peripheral moving object is designated. When the position of the peripheral moving object is not designated (S105: No), the vehicle control device 10 waits until the designated operation is performed.

When the position of the peripheral moving object is designated (S105: Yes), the vehicle control device 10 displays an operation screen 430 for designating a type of the peripheral moving object (S106).

As illustrated in FIG. 8, the operation screen 430 includes a notification 431 such as “What is the type of parked vehicle?” in addition to the vehicle image 401 and the external image 402. The notification 431 includes operation buttons 433 to 435 of “Automobile”, “Motorcycle”, and “Bicycle”, which respectively receive user operations. It is noted that the operation button only needs to designate a type of the peripheral moving object, and may indicate another type. When the type of the peripheral moving object is determined by a known image analysis method or the like, the control unit 11 may highlight an operation button (for example, the operation button 433) indicating the determined type of the moving object among the operation buttons 433 to 435.

The vehicle control device 10 determines whether the type of the peripheral moving object is designated (S107). For example, when any one of the operation buttons 433 to 435 is selected on the operation screen 430, the vehicle control device 10 determines that the type of the peripheral moving object is designated. When the type of the peripheral moving object is not designated (S107: No), the vehicle control device 10 waits until the designated operation is performed.

When the type of the peripheral moving object is designated (S107: Yes), the vehicle control device 10 displays the operation screen 440 for confirming the range of the peripheral moving object (S108).

It is noted that S102, S103, S104, S105, S106, and S107 can be omitted. Thus, it is also possible to directly transition to S108 after Yes in S101.

As illustrated in FIG. 8, the operation screen 440 includes, in addition to the vehicle image 401 and the external image 402, an ambient area 405 corresponding to the moving object, the position and type of which are designated, and a notification 441 such as “Does frame match the vehicle?”. The displayed ambient area 405 is an example of the first ambient area SI and the ambient area S described above. The notification 441 includes operation buttons 443 and 445 of “Yes” and “No”, which respectively receive user operations.

For example, the ambient area 405 may be a display indicating an area in which a moving object, which is a three-dimensional object having a higher possibility of movement than a given degree, is arranged among the ambient areas A1 to A3 of the host vehicle. As illustrated in FIG. 8, the ambient area 405 is displayed around the periphery of the vehicle image 401. The operation screen 440 in FIG. 8 exemplifies a case in which the ambient area 405 corresponding to the ambient area A2 on the right side of the host vehicle is displayed due to the presence of a moving object in the ambient area A2 among the ambient areas A1 to A3 of the host vehicle. Similarly, on the operation screen 440, when a moving object is present in the ambient area A1 or the ambient area A3, the ambient area 405 corresponding to the ambient area A1 on the left side of the host vehicle or the ambient area 405 corresponding to the ambient area A1 on the rear side of the host vehicle is displayed.

For example, the ambient area 405 corresponding to the ambient area A1 on the left side of the host vehicle is arranged along the left side surface of the vehicle image 401. The displayed ambient area 405 corresponding to the ambient area A1 on the left side of the host vehicle is an example of the second ambient area S2.

For example, the ambient area 405 corresponding to the ambient area A2 on the right side of the host vehicle is arranged along the right side surface of the vehicle image 401. The displayed ambient area 405 corresponding to the ambient area A2 on the right side of the host vehicle is an example of the first ambient area S1.

For example, the ambient area 405 corresponding to the ambient area A3 on the rear side of the host vehicle is arranged along the rear part of the vehicle image 401. The displayed ambient area 405 corresponding to the ambient area A3 on the rear side of the host vehicle is an example of the third ambient area S3.

It is noted that FIG. 8 and the following drawings illustrate, as an example, a mode in which the ambient area 405 (ambient area S) to be displayed is a display indicating an area in which a moving object, which is a three-dimensional object having a higher possibility of movement than a given degree, is arranged in the ambient areas A1 to A3 of the host vehicle. However, the ambient area 405 (peripheral region S) to be displayed may be an area in which a three-dimensional object, which is a moving object such as a vehicle, is not arranged. In FIG. 8 and the following drawings, a mode in which the ambient area 405 (first ambient area S1), which is an area in which the moving object is arranged, is displayed is illustrated as an example. However, regardless of whether the moving object is arranged, at least one of the second ambient area S2 and the third ambient area S3 may also be displayed.

It is noted that the size of the ambient area 405 may be slightly larger than the detected moving object from a viewpoint that the feature points are not necessarily obtained over the entire outer shape of the peripheral moving object due to noise or the like.

It is noted that, as illustrated in FIG. 8, the ambient area 405 may be a display of a frame surrounding the detected moving object. In addition, the ambient area 405 may be part of a frame such as a U-shape (corner U-shape) that opens in a direction away from the host vehicle because required accuracy is lower as a distance from the host vehicle increases. Further, the frame of the ambient area 405 is not limited to a rectangle, and may have another shape.

The ambient area 405 may be expressed by the moving object image 403 corresponding to another vehicle different from the vehicle 1. The moving object image 403 is an example of a second vehicle image. It is noted that the moving object image 403 may be an icon of a composite image, or may be an image of an actually captured moving object, in which the image is highlighted by marking or the like. Furthermore, the moving object image 403 does not need to include the entire detected moving object, and may display a part thereof. Furthermore, the icon serving as the moving object image 403 may not exactly match the size of the ambient area 405. For example, the icon may be smaller or larger than the ambient area 405. Furthermore, the icon serving as the moving object image 403 may represent the ambient area 405.

The vehicle control device 10 determines whether to adjust the range of the peripheral moving object (S109). For example, when the operation button 445 of “No” is selected on the operation screen 440, the vehicle control device 10 determines to adjust the range of the peripheral moving object. For example, when the operation button 443 of “Yes” is selected on the operation screen 440, the vehicle control device 10 determines not to adjust the range of the peripheral moving object.

When the range of the peripheral moving object is not adjusted (S109: No), the procedure illustrated in FIG. 7 proceeds to the processing of S113. Thus, when the operation button 445 of “NO” is selected on the operation screen 440 (S109: No), this corresponds to selecting the range of the moving object. It is noted that this range of the moving object can also be regarded as a predetermined ambient area S corresponding to the periphery of the vehicle image 401.

When the range of the peripheral moving object is adjusted (S109: Yes), the vehicle control device 10 displays the operation screen 450 for adjusting the range of the peripheral moving object (S110).

As illustrated in FIG. 8, the operation screen 450 includes the ambient area 405 and a notification 451 such as “Please adjust frame”. The notification 451 includes operation buttons 453 and 454 that respectively give instructions to extend and contract the frame of the ambient area 405 in the forward-and-rearward direction of the vehicle 1, an operation button 455 that gives an instruction to move the frame of the ambient area 405 to the front, rear, left, and right sides of the vehicle 1, and an operation button 456 that gives an instruction to complete adjustment of the frame.

The vehicle control device 10 deforms and displays the frame of the ambient area 405 according to the user operation on the operation buttons 453 to 455 (S111). Thereafter, the vehicle control device 10 determines whether the adjustment is completed (S112). For example, when the operation button 456 of “Completed” is selected on the operation screen 450, the vehicle control device 10 determines that the adjustment is completed. For example, when the operation buttons 453 to 455 are operated on the operation screen 450, the vehicle control device 10 determines that the adjustment is not completed.

When the adjustment is not completed (S112: No), the vehicle control device 10 repeats the processing of S111 and S112. On the other hand, when the adjustment is completed (S112: Yes), the procedure illustrated in FIG. 7 proceeds to the processing of S113. Thus, when the operation button 456 of “Complete” is selected on the operation screen 450 (S112: Yes), this corresponds to selecting the range of the moving object. It is noted that this range of the moving object can also be regarded as a predetermined ambient area S corresponding to the periphery of the vehicle image 401.

The vehicle control device 10 deletes the peripheral moving object from the map data 18B based on the range of the frame of the ambient area 405 (S113). Thus, a teacher route can be registered based on a situation (first three-dimensional object situation) of the external three-dimensional object acquired in the teacher traveling, in which the data corresponding to the ambient area 405 indicating the moving object is deleted. It is noted that the transition to the end is made after S113. Further, after S113, the processing may return to the start without transitioning to the end. In addition, in a case where a forced cancel button is operated in a hard button included in the operation device 20 between S101 and S113 after the start, the transition may be forcibly made to the end, or the transition may be forcibly made to the start.

It is noted that the data to be deleted may be data having a predetermined height stored in an internal memory in a predetermined range of the frame of the ambient area 405. The predetermined height may be a height equal to or higher than the host vehicle, such as 2 m.

As described above, the vehicle control device 10 according to the present disclosure implements a user interface (UI) for designating the presence and position of a peripheral moving object when teacher traveling for teacher data registration is completed. In addition, when the presence and position of the peripheral moving object is designated, the vehicle control device 10 according to the present disclosure registers the map data 18B from which the moving object that cannot be fixedly present has been removed.

Therefore, in the configuration according to the present disclosure, it is possible to register the map data 18B based on the fixed and non-varying feature points, and thus, it is possible to suppress deterioration in accuracy at the time of regenerative traveling due to a peripheral moving object regarding recording-type automatic driving. The suppression of deterioration in accuracy during the regenerative traveling contributes to the suppression of deviation of the parking position during the automatic parking reproduction.

It is noted that the data to be deleted may be, for example, data corresponding to a range corresponding to a designated position and/or type, which is predetermined and stored in the internal memory at a stage where at least one of the position and the type of the peripheral moving object is designated. According to this configuration, it is possible to suppress, while reducing the labor of a user, deterioration in accuracy at the time of regenerative traveling caused by a peripheral moving object regarding recording-type automatic driving through simpler processing.

### Second Embodiment

Here, differences from the first embodiment will be mainly described, and redundant descriptions will be appropriately omitted.

FIG. 9 is a diagram illustrating another example of the display screen displayed in the map editing processing according to the embodiment. FIG. 9 illustrates operation screens 460 to 500 each serving as a display screen in the map editing processing. The operation screens 460 to 500 respectively correspond to the operation screens 410 to 450 illustrated in FIG. 8.

As illustrated in FIG. 9, each of the operation screens 460 to 500 may include display of a feature point 404a (point cloud data) detected during the teacher traveling together with the moving object image 403.

It is noted that a display mode of a feature point 404b in an ambient area 405, such as color, brightness, size, and shape, may be different from that of the other feature point 404a.

In this configuration as well, the same effects as those of the first embodiment can be obtained.

### Third Embodiment

Here, differences from the first embodiment will be mainly described, and redundant descriptions will be appropriately omitted.

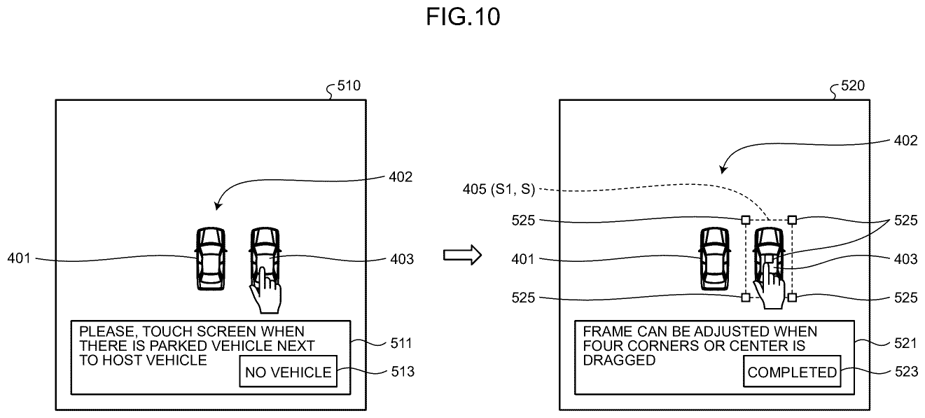

FIG. 10 is a diagram illustrating still another example of the display screen displayed in the map editing processing according to the embodiment. FIG. 10 illustrates operation screens 510 and 520 each serving as a display screen in the map editing processing. The operation screen 510 corresponds to the operation screen 410 to 430 illustrated in FIG. 8. The operation screen 520 corresponds to the operation screens 440 and 450 illustrated in FIG. 8.

The vehicle control device 10 displays the operation screen 510 in the same manner as the operation screen 410.

As illustrated in FIG. 10, the operation screen 510 includes a vehicle image 401 of the host vehicle and a moving object image 403 related to a detected peripheral object. The moving object image 403 may be marked such that an icon of a composite image or an image of an actually captured moving object can be selected. In addition, the operation screen 510 includes a notification 511 such as “Please touch the screen if there is a parked vehicle next to the host vehicle”. The notification 511 includes an operation button 513 of “No vehicle” that receives a user operation.

In a case where the operation button 513 of “No vehicle” is operated, the vehicle control device 10 ends the procedure illustrated in FIG. 7. On the other hand, when the moving object image 403 is operated, the vehicle control device 10 displays the operation screen 520.

As illustrated in FIG. 10, in addition to the vehicle image 401 and the moving object image 403, the operation screen 520 includes an ambient area 405, a notification 521 such as “The frame can be adjusted by dragging four corners or the center”, and an operation icon 525 for adjusting the range of the ambient area 405. The notification 521 includes an operation button 523 of “Completed” that receives a user operation.

The vehicle control device 10 deforms and displays the frame of the ambient area 405 on the operation screen 520 according to the user operation on the operation icon 525.

When a user operation is performed on the operation button 523 on the operation screen 520, the vehicle control device 10 deletes a peripheral moving object from the map data 18B based on the range of the frame of the ambient area 405 at that time.

According to this configuration, it is possible to suppress, while reducing the labor of a user, deterioration in accuracy at the time of regenerative traveling caused by a peripheral moving object regarding recording-type automatic driving through simpler processing.

### Fourth Embodiment

Here, differences from the third embodiment will be mainly described, and redundant descriptions will be appropriately omitted.

In the map editing processing according to the first embodiment, the moving object image 403 may be displayed as an image representing the ambient area 405 corresponding to at least one of the ambient areas A1 to A3 of the parking target position P2 regardless of whether the moving object image is detected at the time of teacher traveling.

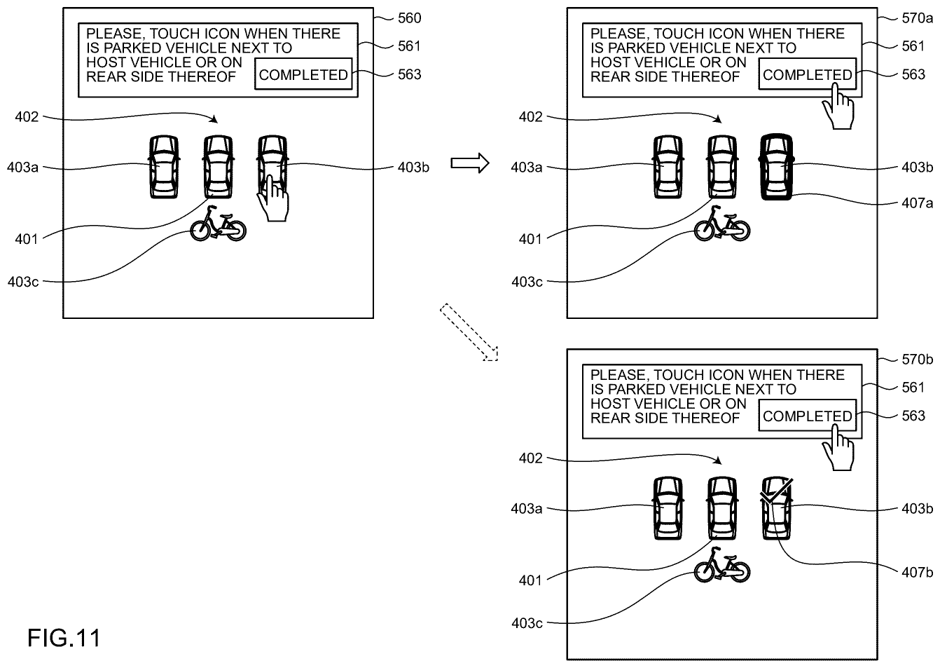

FIG. 11 is a diagram illustrating yet another example of the display screen displayed in the map editing processing according to the embodiment. FIG. 11 illustrates operation screens 560 and 570 each serving as a display screen in the map editing processing. Each of the operation screens 560 and 570 corresponds to the operation screen 510 illustrated in FIG. 10.

The vehicle control device 10 displays the operation screen 560 in the same manner as the operation screen 510.

As illustrated in FIG. 11, the operation screen 560 includes a vehicle image 401 of a host vehicle, a plurality of moving object images 403a, 403b, and 403c, and a notification 561. The notification 561 includes an operation button 563 of “Completed”. The moving object image 403a is an example of the displayed second ambient area S2 corresponding to the left ambient area A1. The moving object image 403b is an example of the displayed first ambient area S1 corresponding to the right ambient area A2. The moving object image 403c is an example of the displayed third ambient area S3 corresponding to the rear ambient area A3.

In a case where the operation button 563 of “Completed” is operated in a state in which none of the moving object images 403 is selected, the vehicle control device 10 ends the procedure illustrated in FIG. 7. On the other hand, when any one of the moving object images 403 is operated, the vehicle control device 10 displays the operation screen 570.

An operation screen 570a as an example of the operation screen 570 performs highlight display 407a on the moving object image 403b selected by the user among the moving object images 403a to 403c.

An operation screen 570b as another example of the operation screen 570 displays a check mark 407b for the moving object image 403b selected by the user among the moving object images 403a to 403c.

When the operation button 563 of “Completed” is operated in a state in which any one of the moving object images 403 is selected, the vehicle control device 10 displays the operation screen including the ambient area 405 corresponding to each of the selected moving objects, similarly to the operation screen 520 in FIG. 10.

In this configuration as well, the same effects as those of the above-described embodiment can be obtained.

### Fifth Embodiment

Here, differences from the fourth embodiment will be mainly described, and redundant descriptions will be appropriately omitted.

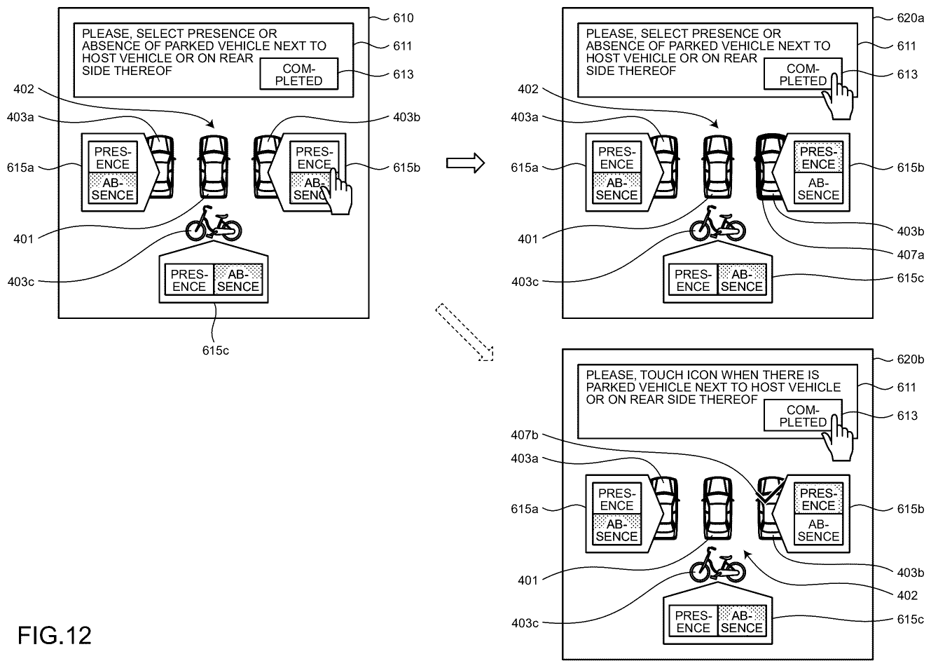

FIG. 12 is a diagram illustrating still yet another example of the display screen displayed in the map editing processing according to the embodiment. FIG. 12 illustrates operation screens 610 and 620 each serving as a display screen in the map editing processing. The operation screens 610 and 620 respectively correspond to the operation screens 560 and 570 illustrated in FIG. 11.

As illustrated in FIG. 12, an operation screen 610 includes a vehicle image 401 of a host vehicle, a plurality of moving object images 403a, 403b, and 403c, a notification 611 such as “Please select presence or absence of a parked vehicle next to the host vehicle or present on the rear side thereof”, and a selection icon 615. The notification 611 includes an operation button 613 of “Completed”. The notification 611 corresponds to the notification 561 in FIG. 11.

The vehicle control device 10 receives selection of the moving object image 403 in accordance with a user operation on the selection icon 615. The vehicle control device 10 displays the operation screen 620 when any selection icon 615 of selection icons 615a, 615b, and 615c is operated to be in the “Present” state.

An operation screen 620a as an example of the operation screen 620 corresponds to the operation screen 570a in FIG. 11, and performs the highlight display 407a on the moving object image 403b corresponding to the selection icon 615b selected as “Present” by the user from among the moving object images 403a to 403c.

The operation screen 570b as another example of the operation screen 570 corresponds to the operation screen 570b in FIG. 11, and displays a check mark 407b for the moving object image 403b corresponding to the selection icon 615b selected as “Present” by the user among the moving object images 403a to 403c.

In this configuration as well, the same effects as those of the above-described embodiment can be obtained.

### Sixth Embodiment

Here, differences from the fifth embodiment will be mainly described, and redundant descriptions will be appropriately omitted.

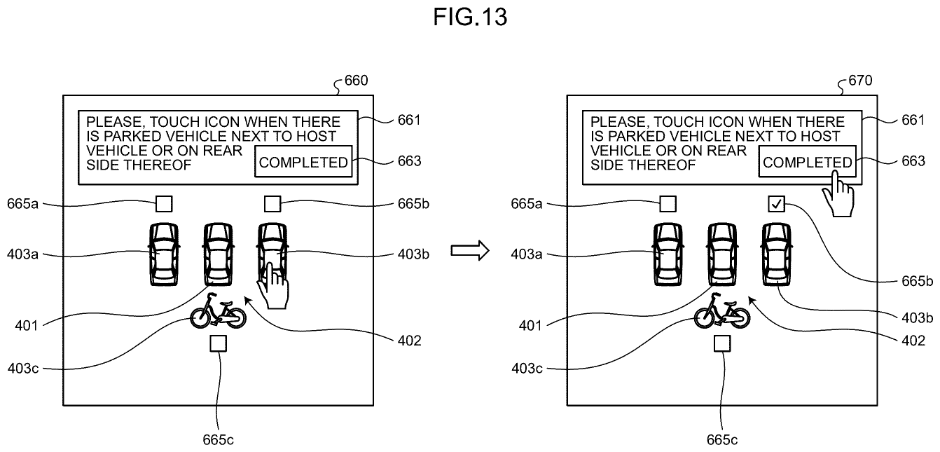

FIG. 13 is a diagram illustrating a further example of the display screen displayed in the map editing processing according to the embodiment. FIG. 13 illustrates operation screens 660 and 670 each serving as a display screen in the map editing processing. The operation screens 660 and 670 respectively correspond to the operation screens 610 and 620 illustrated in FIG. 12.

As illustrated in FIG. 13, the operation screen 660 includes a check box 665 instead of the selection icon 615. A notification 661 corresponds to the notification 611 in FIG. 12. Further, an operation button 663 of the notification 661 corresponds to the operation button 613 in FIG. 12.

The vehicle control device 10 receives selection of the moving object image 403 in accordance with a user operation on the check box 665. When any one check box 665 of check boxes 665a, 665b, and 665c is operated, the vehicle control device 10 displays the operation screen 670.

The operation screen 670 corresponds to the operation screen 570 in FIG. 12, and sets the check box 665b operated by the user among the moving object images 403a to 403c to the “checked” state. At this time, the highlight display 407a or the check mark 407b may be further displayed in the same manner as in FIG. 12 or the like.

In this configuration as well, the same effects as those of the above-described embodiment can be obtained.

### Seventh Embodiment

Here, differences from the fourth to sixth embodiments will be mainly described, and redundant descriptions will be appropriately omitted.

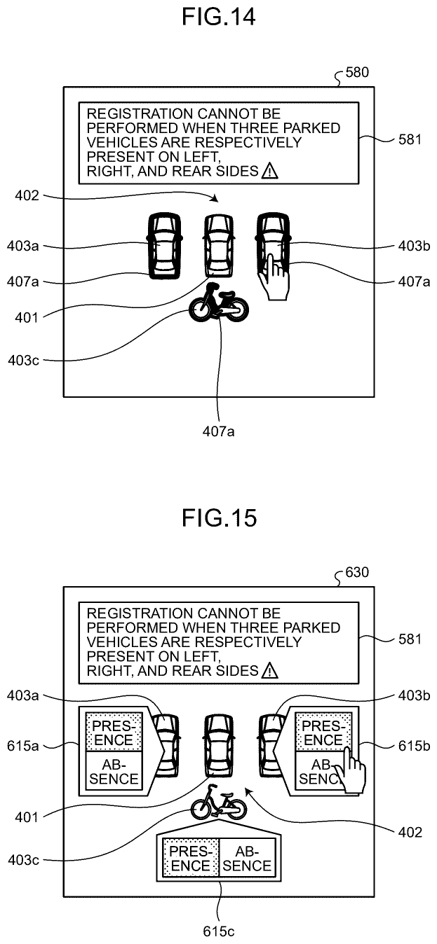

FIG. 14 is a diagram illustrating another further example of the display screen displayed in the map editing processing according to the fourth embodiment. FIG. 14 illustrates an operation screen 580 as a display screen in the map editing processing. When all the moving object images 403a to 403c are selected by the user on the operation screen 570a in FIG. 11, the vehicle control device 10 performs the highlight display 407a on all the moving object images 403a to 403c and displays a notification 581. It is noted that similar processing may be performed on the operation screen 570b in FIG. 11. Here, a case in which all the moving object images 403a to 403c are selected by the user is an example of a case in which the area of the selected ambient area 405 is larger than a predetermined area.

FIG. 15 is a diagram illustrating still another further example of the display screen displayed in the map editing processing according to the firth embodiment. FIG. 15 illustrates an operation screen 630 as a display screen in the map editing processing.

When all the selection icons 615a and 615 are selected by the user and become “Present” on the operation screen 620a in FIG. 12, the vehicle control device 10 displays a notification 581. At this time, all the moving object images 403a to 403c may be shown with the highlight display 407a. It is noted that similar processing may be performed on the operation screen 620b in FIG. 12. Here, a case in which all the selection icons 615a and 615 are selected by the user and become “Present” is an example of a case in which the area of the selected ambient area 405 is larger than the predetermined area.

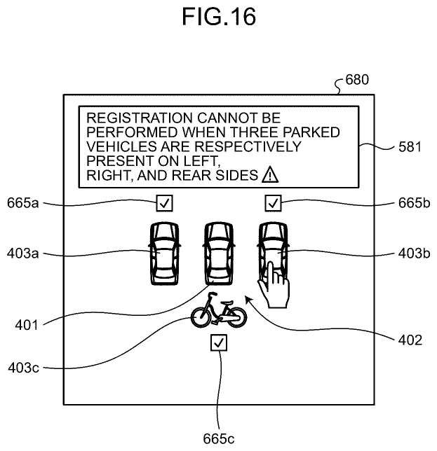

FIG. 16 is a diagram illustrating still yet another further example of the display screen displayed in the map editing processing according to the sixth embodiment. FIG. 16 illustrates an operation screen 680 as a display screen in the map editing processing. The vehicle control device 10 displays a notification 581 when all the check boxes 665a to 665 are selected by the user on the operation screen 670 in FIG. 13 and respectively enter the “checked” states. At this time, all the moving object images 403a to 403c may be shown with the highlight display 407a. It is noted that similar processing may be performed on the operation screen 620b in FIG. 12. Here, a case in which all the check boxes 665a to 665 are selected by the user and respectively enter the “checked” states is an example of a case in which the area of the selected ambient area 405 is larger than the predetermined area

The notification 581 is a notification indicating that registration cannot be performed, for example, “If there are three parked vehicles on the left, right, and rear sides, the registration cannot be performed”. This notification 581 is a notification based on the fact that map data 18B sufficient for self-position estimation cannot be generated when a peripheral moving object is deleted from the map data 18B based on each range of the frames of the ambient areas 405 on the three sides due to the presence of the moving object on the three sides.

When the area of the selected ambient area 405 is larger than the predetermined area, the vehicle control device 10 does not register the teacher route. In this case, the vehicle control device 10 may issue a notification prompting re-implementation of the teacher traveling.

It is noted that the notification 581 is performed, for example, in a case where three sides are selected as described above, but may be performed in a case where the range of the frame of the selected one or two ambient areas 405 becomes larger than a predetermined area set in advance as a result of adjustment by a user operation. For example, it is noted that the size of the predetermined area is assumed to be predetermined and stored in the internal memory.

According to this configuration, it is possible to suppress deterioration in accuracy of self-position estimation due to deletion of data corresponding to a moving object.

It is noted that the techniques according to the above-described embodiments can be appropriately combined.

It is noted that, in each of the above-described embodiments, “whether it is A” means at least one of “it is A” and “it is not A”. Thus, in each of the above-described embodiments, the determination of “whether it is A” may be implemented by determining only “A”, may be implemented by determining only “not A”, or may be implemented by determining both of them.

According to at least one embodiment described above, regarding the recording-type automatic driving, it is possible to suppress deterioration in accuracy during regenerative traveling caused by a peripheral moving object.

Although some embodiments of the present invention have been described, these embodiments have been presented as examples, and are not intended to limit the scope of the invention. These embodiments can be implemented in various other forms, and various omissions, substitutions, and changes can be made without departing from the gist of the invention. These embodiments and modifications thereof are included in the scope and gist of the invention, and are included in the invention described in the claims and the scope equivalent thereto.

### REFERENCE SIGNS LIST

1 vehicle
10 vehicle control device
11 control unit
11A CPU
11B ROM
11C RAM
11D I/F
12 traveling control device
14 sensor
16 camera (sensor)
18 storage device
20 operation device
22 display device

What is claimed is:

1. A vehicle control method executable by a vehicle control device provided in a vehicle, the vehicle including an operation device to receive an operation from a passenger, a sensor to acquire a situation of an external three-dimensional object, a display device being visually recognized by the passenger, and a traveling control device to control at least steering, the vehicle control method comprising:
registering, by the operation of the passenger during teacher traveling, a teacher route based on a first three-dimensional object situation of the external three-dimensional object acquired by the sensor, the teacher traveling being performed by the vehicle to travel from a predetermined position to a parking target position:
causing the traveling control device to control at least the steering to enable the vehicle to perform autonomous traveling from the predetermined position to the parking target position based on the teacher route and an external second three-dimensional object situation acquired by the sensor; and,
before the registering the teacher route, causing the display device to display a vehicle image corresponding to the vehicle and display, around the vehicle image, an ambient area corresponding to a periphery of the vehicle, wherein
the vehicle image displayed on the display device includes
a first side surface part extending in a traveling direction of the vehicle image,
a second side surface part extending in the traveling direction and being located opposite the first side surface part,
one end part in the traveling direction, and
the other end part opposite the one end part in the traveling direction,
the ambient area displayed on the display device is arranged along the first side surface part, and,
when an operation of selecting the ambient area is received by the operation device, data corresponding to the ambient area in the first three-dimensional object situation is deleted and the teacher route is registered.

2. The vehicle control method according to claim 1, wherein
the ambient area displayed on the display device includes a first ambient area and a second ambient area,
the first ambient area is arranged along the first side surface part of the vehicle image displayed on the display device, and
the second ambient area is arranged along the second side surface part of the vehicle image displayed on the display device.

3. The vehicle control method according to claim 2, wherein
the ambient area displayed on the display device further includes a third ambient area, and
the third ambient area is arranged along the one end part of the vehicle image displayed on the display device.

4. The vehicle control method according to claim 1, wherein
the ambient area displayed on the display device has a shape of rectangle, and
one of long sides of the rectangle is arranged along the first side surface part.

5. The vehicle control method according to claim 1, further comprising, before the registering the teacher route, causing the display device to display, in addition to the vehicle image and the ambient area, an indication requesting to select the ambient area in which a three-dimensional object is placed, the three-dimensional object having a higher possibility of movement than a given degree.

6. The vehicle control method according to claim 1, wherein the causing the display device to display the vehicle image and the ambient area is performed after the vehicle in the teacher traveling arrives at the parking target position and before the registering the teacher route.

7. The vehicle control method according to claim 1, wherein the vehicle image is a composite image.

8. The vehicle control method according to claim 1, wherein
the sensor includes an imaging element serving to acquire an image of the external three-dimensional object, and
the method further comprises, before the registering the teacher route, causing the display device to display an external image based on the image and to display the vehicle image and the ambient area by superimposing onto the external image.

9. The vehicle control method according to claim 1, wherein
the vehicle image is defined as a first vehicle image, and
the ambient area is represented by a second vehicle image corresponding to another vehicle different from the vehicle.

10. The vehicle control method according to claim 1, further comprising receiving the operation of selecting the ambient area by the operation device,
wherein the teacher route is not registered when an area of the selected ambient area is larger than a predetermined area.

11. A vehicle control device executable by a vehicle control device provided in a vehicle, the vehicle including an operation device to receive an operation from a passenger, a sensor to acquire a situation of an external three-dimensional object, a display device being visually recognized by the passenger, and a traveling control device to control at least steering, the vehicle control device being configured to perform:
registering, by the operation of the passenger during teacher traveling, a teacher route based on a first three-dimensional object situation of the external three-dimensional object acquired by the sensor, the teacher traveling being performed by the vehicle to travel from a predetermined position to a parking target position:
causing the traveling control device to control at least the steering to enable the vehicle to perform autonomous traveling from the predetermined position to the parking target position based on the teacher route and an external second three-dimensional object situation acquired by the sensor; and,
before the registering the teacher route, causing the display device to display a vehicle image corresponding to the vehicle and display, around the vehicle image, an ambient area corresponding to a periphery of the vehicle, wherein
the vehicle image displayed on the display device includes
a first side surface part extending in a traveling direction of the vehicle image,
a second side surface part extending in the traveling direction and being located opposite the first side surface part,
one end part in the traveling direction, and
the other end part opposite the one end part in the traveling direction,
the ambient area displayed on the display device is arranged along the first side surface part, and,
when an operation of selecting the ambient area is received by the operation device, data corresponding to the ambient area in the first three-dimensional object situation is deleted and the teacher route is registered.

12. The vehicle control device according to claim 11, wherein
the ambient area displayed on the display device includes a first ambient area and a second ambient area,
the first ambient area is arranged along the first side surface part of the vehicle image displayed on the display device, and
the second ambient area is arranged along the second side surface part of the vehicle image displayed on the display device.

13. The vehicle control device according to claim 12, wherein
the ambient area displayed on the display device further includes a third ambient area, and
the third ambient area is arranged along the one end part of the vehicle image displayed on the display device.

14. The vehicle control device according to claim 11, wherein
the ambient area displayed on the display device has a shape of rectangle, and
one of long sides of the rectangle is arranged along the first side surface part.

15. The vehicle control device according to claim 11, wherein the vehicle control device is further configured to perform, before the registering the teacher route, causing the display device to display, in addition to the vehicle image and the ambient area, an indication requesting to select the ambient area in which a three-dimensional object is placed, the three-dimensional object having a higher possibility of movement than a given degree.

16. The vehicle control device according to claim 11, wherein the causing the display device to display the vehicle image and the ambient area is performed after the vehicle in the teacher traveling arrives at the parking target position and before the registering the teacher route.

17. The vehicle control device according to claim 11, wherein the vehicle image is a composite image.

18. The vehicle control device according to claim 11, wherein
the sensor includes an imaging element serving to acquire an image of the external three-dimensional object, and
the vehicle control device is further configured to perform, before the registering the teacher route, causing the display device to display an external image based on the image and to display the vehicle image and the ambient area by superimposing onto the external image.

19. The vehicle control device according to claim 11, wherein
the vehicle image is defined as a first vehicle image, and
the ambient area is represented by a second vehicle image corresponding to another vehicle different from the vehicle.

20. The vehicle control device according to claim 11, wherein
the operation device receives the operation of selecting the ambient area, and
the vehicle control device is configured not to register the teacher route when an area of the selected ambient area is larger than a predetermined area
